(19) United States
(12) Patent Application Publication
(10) Pub. No.: US 2025/0269906 A1
(43) Pub. Date: Aug. 28, 2025

(54) REAR STRUCTURE OF VEHICLE BODY

(71) Applicants: Hyundai Motor Company, Seoul (KR); Kia Corporation, Seoul (KR)

(72) Inventors: HaeHoon Lee, Hwaseong-si (KR); Jinyoung Mo, Hwaseong-si (KR)

(21) Appl. No.: 18/966,877

(22) Filed: Dec. 3, 2024

(30) Foreign Application Priority Data
Feb. 22, 2024 (KR) 10-2024-0025568

(51) Int. Cl. B62D 25/08; B62D 25/02; B62D 27/02

(52) U.S. Cl. CPC B62D 25/08; B62D 25/02; B62D 27/02

(57) ABSTRACT

A rear structure of a vehicle body can be connected to a master side outer assembly of a predetermined shape. The rear structure can include an integrated extension member that can be provided with a rear side outer parting section connected to the master side outer assembly and connected to a rear quarter assembly.

### CROSS-REFERENCE TO RELATED APPLICATIONS

This application claims priority to and the benefit of Korean Patent Application No. 10-2024-0025568 filed in the Korean Intellectual Property Office on Feb. 22, 2024, the entire contents of which are incorporated herein by reference.

### TECHNICAL FIELD

The present disclosure relates to a rear structure of a vehicle body.

### BACKGROUND

Recently, the vehicle industry is introducing a new concept of future mobility vision for realizing a human-centered, dynamic future city. One of these future mobility solutions is a Purpose Built Vehicle (PBV) as purpose-based mobility.

An example of a PBV is an electric vehicle (EV)-based environmentally-friendly mobility vehicle. These PBVs can provide various customized services to users. PBV can be configured in various forms depending on the type of customized service.

For example, the PBV can be used as a hailing type vehicle to transport occupants by configuring cabins in the front and rear of the vehicle body. Additionally, the PBV can be utilized as a delivery type vehicle with a cabin in the front part of the vehicle body and a luggage room in the rear part of the vehicle body.

In the case of the hailing type vehicle, the structure is such that the doors are mounted on the front and rear of the vehicle body, and the quarter glass is mounted on the rear. In the case of delivery type vehicles, the structure is such that the doors are mounted only on the front of the vehicle body, or the doors are mounted on the front and rear, and the quarter glass is not mounted on the rear.

PBVs, such as the hailing type vehicle and the delivery type vehicle, are equipped with rear vehicle body assemblies of various specifications depending on the vehicle type. The rear vehicle body assembly requires a variety of components depending on the specifications.

Therefore, excessive investment in molds to manufacture diversified parts according to various specifications of the rear vehicle body assembly may be spent, and the weight of the vehicle body may increase.

The information contained in this Background section has been prepared to provide understanding of the background of the present disclosure and may include matters that are not prior art and not already publicly known, available, or in use.

### SUMMARY

The present disclosure relates to a vehicle body. More particularly, the present disclosure relates to a rear structure of a vehicle body that can correspond to various types of vehicles.

An embodiment of the present disclosure can provide a rear structure of a vehicle body capable of responding to various specifications of the rear of a vehicle body depending on the vehicle type.

A rear structure of a vehicle body can be connected to a master side outer assembly of a predetermined shape. The rear structure according to an embodiment of the present disclosure may include an integrated extension member that is provided with a rear side outer parting section that is connected to the master side outer assembly and connected to a rear quarter assembly.

The integrated extension member may be provided separately from the master side outer assembly.

The integrated extension member may be connected to the master side outer assembly along the front-rear direction of the vehicle body, and to the rear quarter assembly along the vehicle width direction.

The integrated extension member may be connected to a rear quarter inner member and a rear pillar inner member of the rear quarter assembly.

The rear quarter inner member and the rear pillar inner member may be connected to each other along the vehicle width direction.

The integrated extension member may be connected to the rear quarter inner member and the rear pillar inner member along the vehicle width direction.

The integrated extension member may be connected with the rear pillar inner member to form a rear pillar.

The integrated extension member may be connected to the rear pillar inner member to form a closed section along the vertical direction.

The integrated extension member may include an extension main body, a first junction portion connected to the rear quarter inner member, one edge portion of the rear pillar inner member, and the master side outer assembly, and a second junction portion connected to the other edge portion of the rear pillar inner member.

A closed section may be formed between the extension main body and the rear pillar inner member.

One edge portion of the rear pillar inner member, the first junction portion, and the master side outer assembly may be joined through a 3-layer welding portion

In the state where the rear quarter inner member and the rear pillar inner member are connected together, a first assembly process may be performed in which the integrated extension member is connected to the rear quarter inner member and the rear pillar inner member.

After the first assembly process, a second assembly process may be performed in which the master side outer assembly is connected to the integrated extension member.

In a rear structure of a vehicle body according to an embodiment of the present disclosure, by applying an integrated extension member to the rear part of the vehicle body, the mold investment cost and manufacturing cost for producing a vehicle body of different specifications depending on the vehicle type can be reduced, and the weight of the vehicle body can be reduced.

Advantages that can be obtained or expected from an embodiment of the present disclosure are directly or implicitly disclosed in the detailed description of example embodiments of the present disclosure. Various advantages predicted according to embodiments of the present disclosure will be disclosed in the detailed description to be provided later.

### BRIEF DESCRIPTION OF THE DRAWINGS

Because the drawings are for reference in explaining example embodiments of the present disclosure, technical ideas of the present disclosure should not be interpreted as necessarily limited to the attached drawings.

FIGS. 1A to 1C are drawings illustrating examples of vehicle bodies that can be applied to a rear structure of a vehicle body according to an embodiment of the present disclosure.

FIG. 2 is a perspective view illustrating a rear structure of a vehicle body according to an embodiment of the present disclosure.

FIG. 3 is an exploded perspective view illustrating a rear structure of a vehicle body according to an embodiment of the present disclosure.

FIG. 4 is a side view illustrating a rear structure of a vehicle body according to an embodiment of the present disclosure.

FIG. 5 is a perspective view illustrating an integrated extension member that can be applied to a vehicle body rear structure according to an embodiment of the present disclosure.

FIG. 6 is a cross-sectional view taken along line A-A of FIG. 4.

The drawings referenced above are not necessarily drawn to scale, and can be understood as presenting a somewhat simplified representation of various features illustrating basic principles of the present disclosure. Specific design features of an embodiment, including, for example, specific dimensions, orientation, location, and shape, can be determined in part by a particular intended application and usage environment.

### DETAILED DESCRIPTION OF ILLUSTRATIVE EMBODIMENTS

Hereinafter, with reference to the attached drawings, example embodiments of the present disclosure will be described in detail so that those skilled in the art can easily implement an embodiment of the present disclosure.

As those skilled in the art would realize, the described example embodiments may be modified in various different ways, without departing from the spirit or scopes of the present disclosure.

The terminology used herein is for the purpose of describing particular example embodiments and is not intended to necessarily limit the present disclosure. As used herein, singular forms can be intended to include plural forms as well, unless the context clearly indicates otherwise.

In the detailed description below, the names of the components can be divided into “first,” “second,” etc., to distinguish them when the components are in a similar relationship, and the description below is not necessarily limited to that order based on such adjectives.

It can be understood that the terms “comprises” and/or “comprising” as used herein indicate the presence of stated features, integers, steps, operations, elements, and/or components, but do not preclude the presence or addition of one or more other features, integers, steps, operations, components, and/or groups thereof.

As used herein, the term “and/or” includes any and all combinations of one or more of the associated listed items.

The term “connected” in this specification can denote a physical relationship between two components that are directly connected to each other or indirectly connected through one or more intermediary components.

As used herein, “vehicle,” “vehicular,” “automotive,” or other similar terms as used herein, generally can refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs (Purpose Built Vehicles), hydrogen-powered vehicles and other alternative fuel vehicles (e.g., other than petroleum fuel derived from resources), for example.

Hereinafter, example embodiments of the present disclosure will be described in detail with reference to the attached drawings.

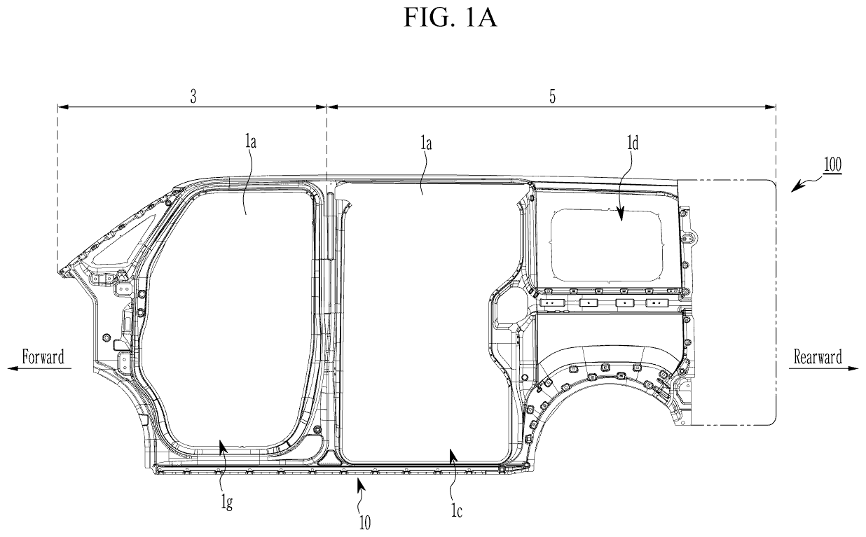

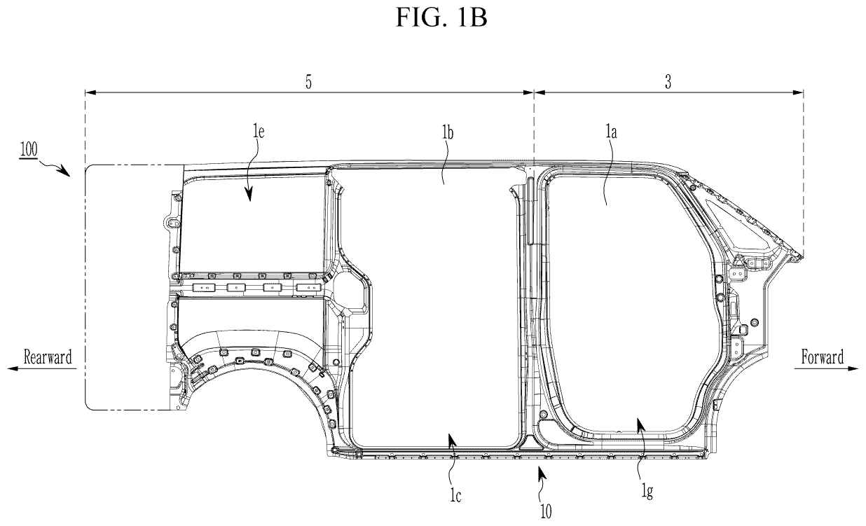

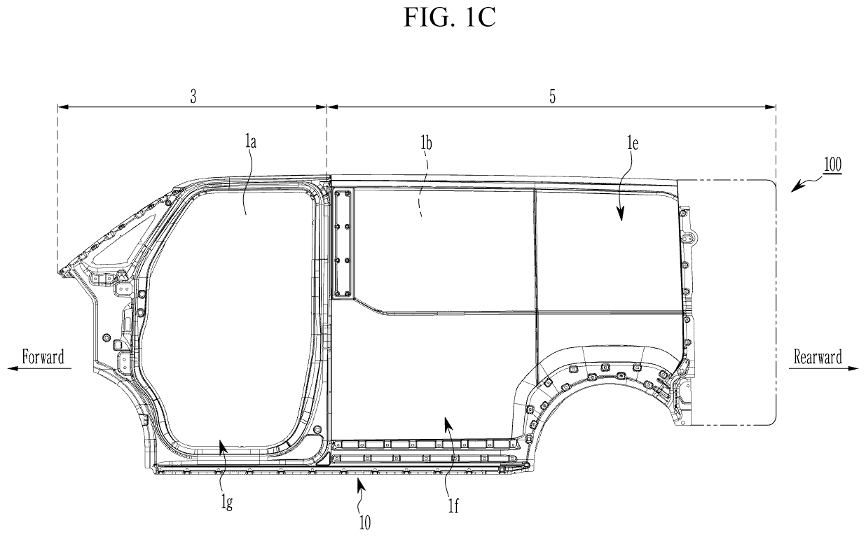

FIGS. 1A to 1C are drawings illustrating examples of vehicle bodies that can be applied to a rear structure of a vehicle body according to an embodiment of the present disclosure.

Referring to FIGS. 1A to 1C, the rear structure of a vehicle body 100 according to an embodiment can be applied to, for example, a vehicle body of a purpose-based mobility vehicle (Purpose Built Vehicle: hereinafter referred to as ‘PBV’).

The PBV can be utilized as an electric car-based life module vehicle that provides various customized services to users during the time it takes to move from the departure point to the destination.

The vehicle body of these PBVs can be configured in various shapes depending on the intended use of the PBV.

In this specification, the reference direction for describing the components below may be set as the vehicle body front-rear direction (e.g., vehicle body length direction or longitudinal direction), vehicle width direction (e.g., left-right direction or lateral direction), and vertical direction (e.g., height direction) with the vehicle body as reference.

In this specification, “upper end,” “upper portion,” or “upper surface” of a component can indicate an end, portion, or surface of a component that is relatively upper in the drawing, and “lower end,” “lower portion,” or “lower surface” of a component can indicate an end, portion, or surface of a component that is relatively lower in the drawing.

Furthermore, in this specification, an end of a component (e.g., one end or another (other) end, etc.) can denote an end of a component in any one direction, and an end portion of the component (e.g., one end portion) or other (another) end portion, etc.) can denote a portion of a component that includes that end.

The vehicle body of the PBV can be utilized as a hailing vehicle type vehicle, as shown in FIG. 1A, with a cabin 1a configured in the front and rear to transport occupants.

The vehicle body of the PBV can also be utilized as a delivery vehicle type vehicle, as shown in FIGS. 1B and 1C, in another example, with a cabin 1a configured in the front and a luggage room 1b configured in the rear to transport various loads.

The vehicle body of the hailing vehicle type as illustrated in FIG. 1A may include a sliding door mount region 1c and a quarter glass mount region 1d.

The vehicle body of the delivery vehicle type as illustrated in FIG. 1B may include a sliding door mount region 1c and a quarter glass-less region 1e.

The vehicle body of the delivery vehicle type may include a sliding door-less region if and a quarter glass-less region 1e, as shown in FIG. 1C.

As described above, in a vehicle body having a different structure depending on the vehicle type, the front portion may be a fixed portion (fixed part) 3 in which a front door mount region 1g is formed. The fixed portion 3 here can be defined as a configuration that does not change even if the intended use of the vehicle is changed in an embodiment.

The rear portion of the above-mentioned vehicle body may be a replaceable portion (replaceable part) 5. The replaceable portion 5 here can be defined as a configuration that can be changed to various specifications depending on the intended use of the vehicle in an embodiment.

The rear structure of a vehicle body 100 according to an embodiment can provide a structure capable of responding to replaceable portion 5 of different specifications depending on the various vehicle type. The various vehicle types here can refer to various configurations of replaceable portion 5.

The rear structure of a vehicle body 100 according to an embodiment can be connected to a master side outer assembly 10 of a predetermined shape as illustrated in FIGS. 1A to 1C.

The master side outer assembly 10 can be a side structure assembled on the side of the vehicle body, and can be a structure in which the region covering the rear end of the replaceable portion 5 can be deleted.

According to an embodiment of the present disclosure, a rear structure of a vehicle body 100 can provide a structure connected to the master side outer assembly 10 as described above, thereby reducing the thickness of the side structure body and maximizing the common use of a mold for manufacturing the side structure body.

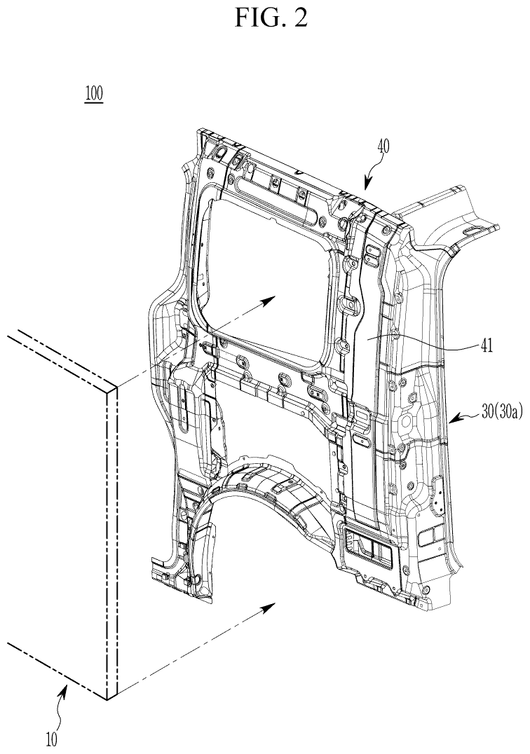

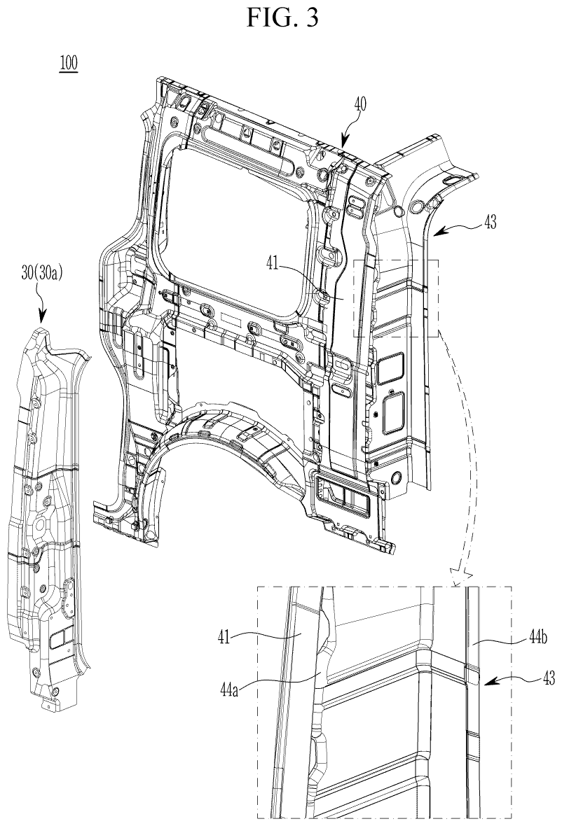

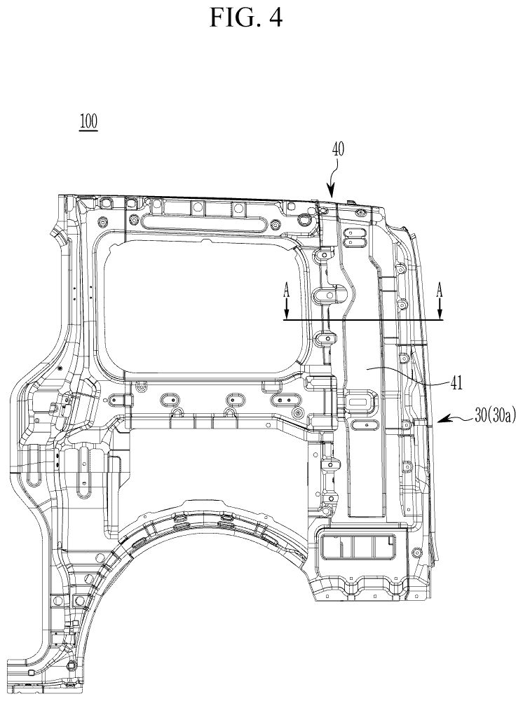

FIG. 2 is a perspective view illustrating a rear structure of a vehicle body according to an embodiment of the present disclosure. FIG. 3 is an exploded perspective view illustrating a rear structure of a vehicle body according to an embodiment of the present disclosure. FIG. 4 is a side view illustrating a rear structure of a vehicle body according to an embodiment of the present disclosure.

Referring to FIGS. 2 to 4, a rear structure of a vehicle body 100 according to an embodiment can include an integrated extension member 30.

The integrated extension member 30 herein can be defined as a configuration that shares some of the components of the replaceable portion 5 as illustrated in FIGS. 1A to 1C.

The integrated extension member 30 can be manufactured in various shapes and sizes to correspond to the specifications of different replaceable portions 5 depending on various the vehicle type.

In an embodiment, the integrated extension member 30 may be provided with a rear side outer parting section 30a connectable with the master side outer assembly 10.

The integrated extension member 30 can be configured to perform the function of the deleted rear end portion of the side structure and can be connected to the master side outer assembly 10 along the front-rear direction of the vehicle body.

The integrated extension member 30 can be connected to a rear quarter assembly 40. The integrated extension member 30 can be provided separately from the master side outer assembly 10 and can be connected to the rear quarter assembly 40 along the vehicle width direction.

The rear quarter assembly 40 can be connected to the rear portion of the master side outer assembly 10 and can be connected to the integrated extension member 30.

The rear quarter assembly 40 may be assembled by combining a plurality of rear quarter parts. For example, the rear quarter assembly 40 may include a rear quarter inner member 41 and a rear pillar inner member 43.

The rear quarter inner member 41 can be arranged along the vertical direction at the rear part of the rear quarter assembly 40. The rear pillar inner member 43 can be connected to the rear quarter inner member 41 and can be arranged along the vertical direction.

The rear quarter inner member 41 and the rear pillar inner member 43 can be connected to each other along the vehicle width direction.

The integrated extension member 30 can be connected to the rear quarter inner member 41 and the rear pillar inner member 43, which are coupled together, along the vehicle width direction and can be arranged along the vertical direction.

The rear pillar inner member 43 can include a first flange 44a formed on one edge portion and a second flange 44b formed on the other edge portion.

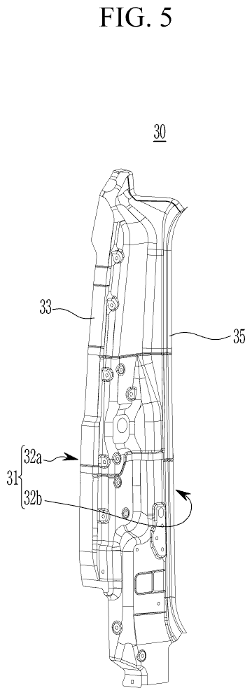

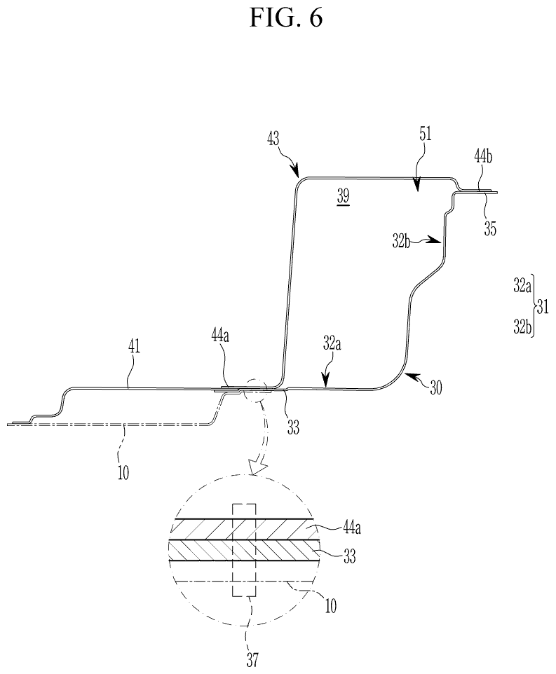

FIG. 5 is a perspective view illustrating an integrated extension member 30 that can be applied to a vehicle body rear structure according to an embodiment of the present disclosure. FIG. 6 is a cross-sectional view along line A-A of FIG. 4.

Referring to FIGS. 2 to 6, an integrated extension member 30 according to an embodiment can include an extension main body 31, a first junction portion 33, and a second junction portion 35.

The extension main body 31 can include a first part 32a connected to the rear quarter inner member 41 and the rear pillar inner member 43, and a second part 32b extended from the first part 32a and connected to the rear pillar inner member 43.

The first junction portion 33 can be formed at the edge portion of the first part 32a. The first junction portion 33 can be connected by welding to the rear portion of the rear quarter inner member 41, the first flange 44a of the rear pillar inner member 43, and the rear portion of the master side outer assembly 10.

The first junction portion 33, the first flange 44a of the rear pillar inner member 43, and the rear portion of the master side outer assembly 10 can be connected through a 3-layer welding portion 37.

The second junction portion 35 can be connected to the second flange 44b of the rear pillar inner member 43 by welding.

The integrated extension member 30 may be combined with the rear pillar inner member 43 to form a rear pillar 39.

The integrated extension member 30 may form a closed section 51 connected to the rear pillar inner member 43 along the vertical direction. The closed section 51 can be formed between the extension main body 31 and the rear pillar inner member 43.

Accordingly, an integrated extension member 30 according to an embodiment as described above can be provided as a structure integrating a side outer extension member and a rear pillar reinforcement member assembled in the rear quarter of various vehicle body of the PBV.

In this way, an integrated extension member 30 according to an embodiment may reduce the replaceable portion rear region of the rear quarter assembly 40 and simplify the cross-section elements of the skeleton constituting the rear pillar 39.

An integrated extension member 30 according to an embodiment may increase the cross-section of the rear pillar 39 because it can perform the role of the deleted rear end portion of the side structure and the role of the rear pillar reinforcement member of a typical PBV vehicle body.

An integrated extension member 30 according to an embodiment may be directly joined to the rear pillar inner member 43 and the master side outer assembly 10 via a 3-layer welding portion 37.

Accordingly, an integrated extension member 30 according to an embodiment may increase the assemble efficiency of the rear of the vehicle body and strengthen the joint rigidity and connectivity of the rear of the vehicle body.

An assembly process of the rear structure of a vehicle body 100 according to an embodiment configured as described above will be described with reference to FIG. 2 and referring to FIG. 6. First, the rear quarter inner member 41 and the rear pillar inner member 43 of the rear quarter assembly 40 can be coupled to each other along the vehicle width direction (see FIG. 3).

In this state, a first assembly process can be performed in which the integrated extension member 30 can be joined to the rear quarter inner member 41 and the rear pillar inner member 43.

The integrated extension member 30 can be connected to the rear portion of the rear quarter inner member 41 and the first flange 44a of the rear pillar inner member 43 via the first junction portion 33.

The integrated extension member 30 can be connected to the second flange 44b of the rear pillar inner member 43 by welding through the second junction portion 35.

After the first assembly process, a secondary assembly process can be performed in which the master side outer assembly 10 can be joined to the first junction portion 33 of the integrated extension member 30 (see FIG. 2).

Therefore, the first junction portion 33, the first flange 44a of the rear pillar inner member 43, and the rear portion of the master side outer assembly 10 may be joined through a 3-layer welding portion 37 (see FIG. 6).

The rear structure of a vehicle body 100 according to an embodiment described so far may reduce mold investment cost and manufacturing cost for producing a vehicle body of various specifications according to the vehicle type by applying an integrated extension member 30, and may reduce the weight of the vehicle body.

The rear structure of a vehicle body 100 according to an embodiment may secure the rigidity of the rear of the vehicle body by applying an integrated extension member 30.

Although the example embodiments of the present disclosure have been described above, the present disclosure is not necessarily limited thereto, and various modifications may be made within the scopes of the claims, the detailed description of the present disclosure, and the attached drawings, and equivalents thereof, which can also fall within the scopes of the present disclosure.

What is claimed is:

1. A rear structure of a vehicle body connected to a master side outer assembly of a predetermined shape, the rear structure comprising an integrated extension member, wherein the integrated extension member includes a rear side outer parting section, wherein the rear side outer parting section is connected to the master side outer assembly and connected to a rear quarter assembly.

2. The rear structure of claim 1, wherein the integrated extension member is provided separately from the master side outer assembly,
wherein the integrated extension member is connected to the master side outer assembly along a front-rear direction of the vehicle body, and
wherein the integrated extension member is connected to the rear quarter assembly along a vehicle width direction of the vehicle body.

3. The rear structure of claim 1, wherein the integrated extension member is connected to a rear quarter inner member and a rear pillar inner member of the rear quarter assembly.

4. The rear structure of claim 3, wherein the rear quarter inner member and the rear pillar inner member are connected to each other along a vehicle width direction; and
wherein the integrated extension member is connected to the rear quarter inner member and the rear pillar inner member along the vehicle width direction.

5. The rear structure of claim 3, wherein the integrated extension member is connected with the rear pillar inner member to form a rear pillar.

6. The rear structure of claim 3, wherein the integrated extension member is connected to the rear pillar inner member to form a closed section therebetween along a vertical direction.

7. The rear structure of claim 3, wherein the integrated extension member comprises:
an extension main body;
a first junction portion connected to the rear quarter inner member, a first edge portion of the rear pillar inner member, and the master side outer assembly; and
a second junction portion connected to a second edge portion of the rear pillar inner member.

8. The rear structure of claim 7, wherein a closed section is formed between the extension main body and the rear pillar inner member.

9. The rear structure of claim 7, wherein the first edge portion of the rear pillar inner member, the first junction portion, and the master side outer assembly are joined through a 3-layer welding portion.

10. The rear structure of claim 3, wherein the integrated extension member being connected to the rear quarter inner member and the rear pillar inner member is provided by a first assembly process performed to connect the integrated extension member to the rear quarter inner member and the rear pillar inner member in a state where the rear quarter inner member and the rear pillar inner member are connected together.

11. The rear structure of claim 10, wherein after the first assembly process, the master side outer assembly being connected to the integrated extension member is provided by a second assembly process performed to connect the master side outer assembly to the integrated extension member.

12. A vehicle body comprising:
a rear quarter assembly comprising a rear quarter inner member and a rear pillar inner member, wherein the rear quarter inner member and the rear pillar inner member are connected to each other along a vehicle width direction of the vehicle body;
a master side outer assembly of a predetermined shape; and
an integrated extension member, wherein the integrated extension member comprises:
a rear side outer parting section;
an extension main body;
a first junction portion connected to the rear quarter inner member, a first edge portion of the rear pillar inner member, and the master side outer assembly; and
a second junction portion connected to a second edge portion of the rear pillar inner member,
wherein the rear side outer parting section is connected to the master side outer assembly and connected to the rear quarter assembly,
wherein the integrated extension member is connected to the rear quarter inner member and the rear pillar inner member of the rear quarter assembly,
wherein the integrated extension member is provided separately from the master side outer assembly before being connected to the master side outer assembly,
wherein the integrated extension member is connected to the master side outer assembly along a front-rear direction of the vehicle body,
wherein the integrated extension member is connected to the rear quarter assembly along the vehicle width direction,
wherein the integrated extension member is connected to the rear quarter inner member and the rear pillar inner member along the vehicle width direction,
wherein the integrated extension member is connected with the rear pillar inner member to form a rear pillar, and
wherein a closed section is formed for the rear pillar between the extension main body and the rear pillar inner member by the integrated extension member being connected to the rear pillar inner member to form the closed section therebetween along a vertical direction.

13. The vehicle body of claim 12, wherein the first edge portion of the rear pillar inner member, the first junction portion, and the master side outer assembly are joined through a 3-layer welding portion.

14. The vehicle body of claim 12, wherein the integrated extension member is modular component configured to be used with two or more different replaceable vehicle body portions configured depending on an intended use of a vehicle incorporating the vehicle body.

15. The vehicle body of claim 12, wherein the integrated extension member and the master side outer assembly are modular components configured to be used with two or more different replaceable vehicle body portions configured depending on an intended use of a vehicle incorporating the vehicle body.

16. The vehicle body of claim 12, wherein the integrated extension member, at least part of the rear quarter assembly, and at least part of the master side outer assembly are modular components configured to be used with two or more different replaceable vehicle body portions configured depending on an intended use of a vehicle incorporating the vehicle body.
